(19) United States
(12) Patent Application Publication
(10) Pub. No.: US 2014/0314092 A1
(43) Pub. Date: Oct. 23, 2014

(54) COMMUNICATION SYSTEM, COMMUNICATION METHOD, EDGE DEVICE, EDGE DEVICE CONTROL METHOD, EDGE DEVICE CONTROL PROGRAM, NON-EDGE DEVICE, NON-EDGE DEVICE CONTROL METHOD, AND NON-EDGE DEVICE CONTROL PROGRAM

(71) Applicant: Noriaki Kishita, Tokyo (JP)

(72) Inventor: Noriaki Kishita, Tokyo (JP)

(21) Appl. No.: 14/354,913

(22) PCT Filed: Jun. 12, 2012
(86) PCT No.: PCT/JP2012/003810

§ 371 Date: Apr. 28, 2014

(30) Foreign Application Priority Data
Oct. 31, 2011 (JP) 2011-238238

(51) Int. Cl. H04L 12/723

(52) U.S. Cl. CPC H04L 45/502
USPC 370/392

(57) ABSTRACT

A communication system includes an Ethernet™ network and a MPLS-TP network connected with each other. A communication device transmits an OAM frame including frame type information showing that a frame type is an OAM frame, MPLS communication device identification information for identifying a communication device configuring the MPLS-TP network, and process content information showing a process content. When the type of a frame from the Ethernet network is an OAM frame, an edge device provides the frame with header information including an OAM identifier including MPLS communication device identification information included by the frame. When a communication device identified based on MPLS communication device identification information included by an OAM identifier of header information of a received frame is the device itself, a communication device executes an OAM process based on a process content shown by process content information.

### TECHNICAL FIELD

The present invention relates to a communication system composed of an Ethernet™ network and a MPLS-TP (Multi Protocol Label Switching Transport Profile) network connected with each other.

### BACKGROUND ART

A communication system composed of an Ethernet™ network and a MPLS-TP (Multi Protocol Label Switching Transport Profile) network connected with each other is known.

In a communication system described in Patent Document 1 as one of this type of communication systems, communication devices configuring an Ethernet network each transmit an OAM frame that includes frame type information, MPLS communication device identification information, and process content information.

Frame type information is information showing that the type of a frame is an OAM (Operations, Administration and Maintenance) frame. MPLS communication device identification information is information for identifying each of communication devices configuring a MPLS-TP network. Process content information is information showing the content of a process.

When an edge device, which is a communication device connected to the Ethernet network of the communication devices configuring the MPLS-TP network, receives a frame from the Ethernet network, the edge device executes an encapsulation process, which is a process of providing the frame with header information for transferring the frame through the MPLS-TP network.
Patent Document 1: Japanese Unexamined Patent Application Publication (Translation of PCT application) No. 2010-514368

In the case of executing an OAM process (e.g., the loopback process) through the MPLS-TP network, when the destination of an OAM frame is a MIP (Maintenance Intermediate Point), it is usual to use a TTL (Time To Live) value in order to transfer the OAM frame.

A TTL value is decreased by 1 every time a communication device transfers a frame. Then, when a TTL value included in a received OAM frame becomes 0, the MIP configuring the MPLS-TP network executes an OAM process based on the OAM frame.

Therefore, in the above communication system, the edge device needs to previously store a table in which MPLS communication device identification information for identifying a MIP and a TTL value are associated and, when receiving an OAM frame from the Ethernet network, convert MPLS communication device identification information included by the OAM frame into a TTL value based on the table.

In other words, in the above communication system, the edge device needs to secure a storage region for storing the above table. Thus, in order to secure this storage region (e.g., provide an additional memory, or make the storage capacity of a memory larger), it costs much to produce the communication system.

Further, when the configuration of the MPLS-TP network is changed (e.g., a MIP is added, or a MIP is eliminated), there is a need to also update the above table stored by the edge device in accordance with the change. Thus, the cost of operating the communication system is relatively high.

Accordingly, the above communication system has a problem that the cost of producing the communication system and the cost of operating the communication system are likely to be excessively high.

### SUMMARY

Accordingly, an object of the present invention is to provide a communication system which is capable of solving the abovementioned problem, “there is a case where the cost of producing the communication system and the cost of operating the communication system are excessively high.”

In order to achieve the object, a communication system as an aspect of the present invention is a system in which an Ethernet™ network and a MPLS-TP (Multi Protocol Label Switching Transport Profile) network are connected with each other.

Moreover, in this communication system,

a communication device configuring the Ethernet network includes an OAM frame transmitting means for transmitting an OAM frame that includes frame type information showing that a frame type is an OAM (Operations, Administration and Maintenance) frame, MPLS communication device identification information for identifying a communication device configuring the MPLS-TP network, and process content information showing a content of a process;

an edge device, which is a communication device connected with the Ethernet network among communication devices configuring the MPLS-TP network, includes an encapsulation process executing means for, when the edge device receives a frame from the Ethernet network, executing an encapsulation process of providing the frame with header information for transferring the frame through the MPLS-TP network;

the encapsulation process executing means is configured to, in a case where frame type information included by the received frame shows that a frame type is an OAM frame, provide the frame with header information including an OAM identifier including MPLS communication device identification information included by the frame; and

the communication device configuring the MPLS-TP network includes an OAM process executing means for, when the communication device receives a frame and in a case where header information of the frame includes an OAM identifier and a communication device identified based on MPLS communication device identification information included by the OAM identifier is the device itself, executing an OAM process based on a content of a process shown by process content information included by the frame.

Further, a communication method as another aspect of the present invention is a method applied to a communication system in which an Ethernet™ network and a MPLS-TP (Multi Protocol Label Switching Transport Profile) network are connected with each other.

Moreover, this communication method includes:

transmitting an OAM frame that includes frame type information showing that a frame type is an OAM (Operations, Administration and Maintenance) frame, MPLS communication device identification information for identifying a communication device configuring the MPLS-TP network, and process content information showing a content of a process, by a communication device configuring the Ethernet network; and

executing an encapsulation process of providing a frame with header information for transferring the frame through the MPLS-TP network when an edge device, which is a communication device connected with the Ethernet network among communication devices configuring the MPLS-TP network, receives the frame from the Ethernet network, by the edge device.

The encapsulation process is configured to, in a case where frame type information included by the received frame shows that a frame type is an OAM frame, provide the frame with header information including an OAM identifier including MPLS communication device identification information included by the frame.

The communication method further includes:

executing an OAM process based on a content of a process shown by process content information included by a frame when the communication device configuring the MPLS-TP network receives the frame and in a case where header information of the frame includes an OAM identifier and a communication device identified based on MPLS communication device identification information included by the OAM identifier is the device itself, by the communication device.

Further, an edge device as another aspect of the present invention is a communication device connected with an Ethernet™ network among communication devices configuring a MPLS-TP (Multi Protocol Label Switching Transport Profile) network.

Moreover, this edge device includes an encapsulation process executing means for, when the edge device receives a frame from the Ethernet network, executing an encapsulation process of providing the frame with header information for transferring the frame through the MPLS-TP network.

The encapsulation process executing means is configured to, in a case where frame type information included by the received frame shows that a frame type is an OAM (Operations, Administration and Maintenance) frame, provide the frame with header information including an OAM identifier including MPLS communication device identification information for identifying a communication device configuring the MPLS-TP network, the MPLS communication device identification information being included by the frame.

The edge device further includes an OAM process executing means for, when the edge device receives a frame and in a case where header information of the frame includes an OAM identifier and a communication device identified based on MPLS communication device identification information included by the OAM identifier is the device itself, executing an OAM process based on a content of a process shown by process content information included by the frame.

Further, an edge device control method as another aspect of the present invention is a method applied to an edge device, which is a communication device connected with an Ethernet™ network among communication devices configuring a MPLS-TP (Multi Protocol Label Switching Transport Profile) network.

Moreover, this edge device control method includes executing an encapsulation process of providing a frame with header information for transferring the frame through the MPLS-TP network when the edge device receives the frame from the Ethernet network.

The encapsulation process is configured to, in a case where frame type information included by the received frame shows that a frame type is an OAM (Operations, Administration and Maintenance) frame, provide the frame with header information including an OAM identifier including MPLS communication device identification information for identifying a communication device configuring the MPLS-TP network, the MPLS communication device identification information being included by the frame.

The edge device control method further includes executing an OAM process based on a content of a process shown by process content information included by a frame when the edge device receives the frame and in a case where header information of the frame includes an OAM identifier and a communication device identified based on MPLS communication device identification information included by the OAM identifier is the device itself.

Further, an edge device control program as another aspect of the present invention is a program executed by an edge device, which is a communication device connected with an Ethernet™ network among communication devices configuring a MPLS-TP (Multi Protocol Label Switching Transport Profile) network.

Moreover, this edge device control program includes instructions for causing the edge device to execute an encapsulation process of providing a frame with header information for transferring the frame through the MPLS-TP network when the edge device receives the frame from the Ethernet network.

The encapsulation process is configured to, in a case where frame type information included by the received frame shows that a frame type is an OAM (Operations, Administration and Maintenance) frame, provide the frame with header information including an OAM identifier including MPLS communication device identification information for identifying a communication device configuring the MPLS-TP network, the MPLS communication device identification information being included by the frame.

The edge device control program further includes instructions for causing the edge device to execute an OAM process based on a content of a process shown by process content information included by a frame when the edge device receives the frame and in a case where header information of the frame includes an OAM identifier and a communication device identified based on MPLS communication device identification information included by the OAM identifier is the device itself.

Further, a non-edge device as another aspect of the present invention is a communication device connected with only a communication device configuring a MPLS-TP (Multi Protocol Label Switching Transport Profile) network, among communication devices configuring the MPLS-TP network.

Moreover, this non-edge device includes an OAM (Operations, Administration and Maintenance) process executing means for, when the non-edge device receives a frame and in a case where header information of the frame includes an OAM identifier and a communication device identified based on MPLS communication device identification information that is for identifying the communication device configuring the MPLS-TP network and that is included by the OAM identifier is the device itself, executing an OAM process based on a content of a process shown by process content information included by the frame.

Further, a non-edge device control method as another aspect of the present invention is a method applied to a non-edge device, which is a communication device connected with only a communication device configuring a MPLS-TP (Multi Protocol Label Switching Transport Profile) network, among communication devices configuring the MPLS-TP network.

Moreover, this non-edge device control method includes executing an OAM (Operations, Administration and Maintenance) process based on a content of a process shown by process content information included by a frame when the non-edge device receives the frame and in a case where header information of the frame includes an OAM identifier and a communication device identified based on MPLS communication device identification information that is for identifying a communication device configuring the MPLS-TP network and that is included by the OAM identifier is the device itself.

Further, a non-edge device control program as another aspect of the present invention is a program executed by a non-edge device, which is a communication device connected with only a communication device configuring a MPLS-TP (Multi Protocol Label Switching Transport Profile) network, among communication devices configuring the MPLS-TP network.

Moreover, this non-edge device control program includes instructions for causing the non-edge device to execute an OAM (Operations, Administration and Maintenance) process based on a content of a process shown by process content information included by a frame when the non-edge device receives the frame and in a case where header information of the frame includes an OAM identifier and a communication device identified based on MPLS communication device identification information that is for identifying the communication device configuring the MPLS-TP network and that is included by the OAM identifier is the device itself.

Configured as described above, the present invention can reduce the production cost and the operation cost.

### BRIEF DESCRIPTION OF DRAWINGS

FIG. 1 is a diagram showing the schematic configuration of a communication system according to a first exemplary embodiment of the present invention;

FIG. 2 is a block diagram schematically showing the function of a communication device configuring an Ethernet network according to the first exemplary embodiment of the present invention;

FIG. 3 is an explanation diagram conceptually showing an OAM frame in the Ethernet network in the first exemplary embodiment of the present invention;

FIG. 4 is a block diagram schematically showing the function of an edge device of communication devices configuring a MPLS-TP network according to the first exemplary embodiment of the present invention;

FIG. 5 is an explanation diagram conceptually showing an OAM frame in the MPLS-TP network in the first exemplary embodiment of the present invention;

FIG. 6 is a block diagram schematically showing the function of a non-edge device of the communication devices configuring the MPLS-TP network in the first exemplary embodiment of the present invention;

FIG. 7 is a flowchart showing a process that the edge device executes when receiving an Ethernet frame in the first exemplary embodiment of the present invention;

FIG. 8 is a flowchart showing a process that the non-edge device executes in the first exemplary embodiment of the present invention;

FIG. 9 is a flowchart showing a process that the edge device executes when receiving a MPLS frame in the first exemplary embodiment of the present invention;

FIG. 10 is an explanation diagram conceptually showing an example of an operation of the communication system according to the first exemplary embodiment of the present invention; and

FIG. 11 is a block diagram schematically showing the function of a communication system according to a second exemplary embodiment of the present invention.

### EXEMPLARY EMBODIMENTS

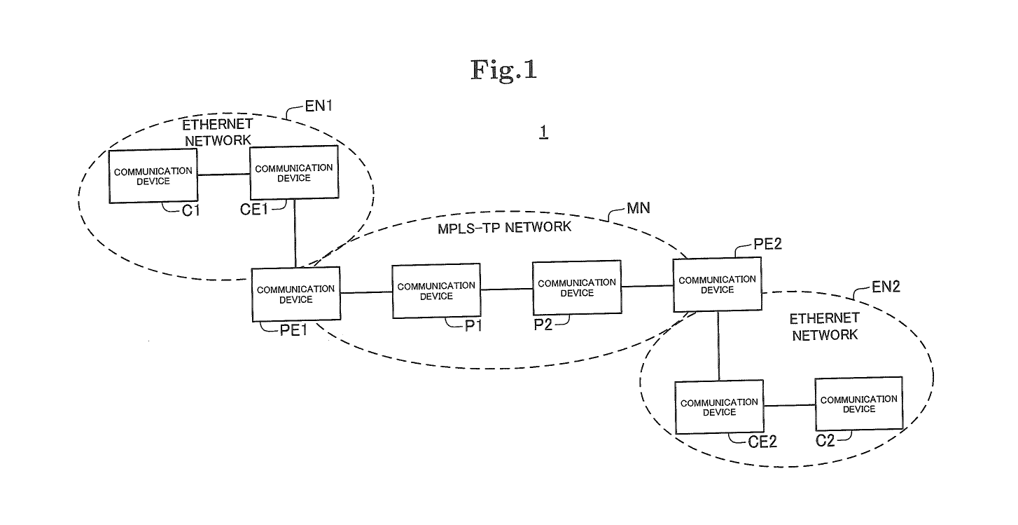

Below, exemplary embodiments of a communication system, a communication method, an edge device, an edge device control method, an edge device control program, a non-edge device, a non-edge device control method, and a non-edge device control program according to the present invention will be described referring to FIGS. 1 to 11.

### First Exemplary Embodiment

### Configuration

As shown in FIG. 1, a communication system 1 according to a first exemplary embodiment includes a plurality of communication devices C1, CE1, PE1, P1, P2, PE2, CE2 and C2. In this exemplary embodiment, each of the communication devices C1, CE1, PE1, P1, P2, PE2, CE2 and C2 is a router device that relays a frame. Each of the communication devices C1, CE1, PE1, P1, P2, PE2, CE2 and C2 may be a network switch.

The communication device C1 and the communication device CE1 configure an Ethernet™ network EN1. The communication device PE1, the communication device P1, the communication device P2, and the communication device PE2 configure a MPLS-TP (Multi Protocol Label Switching Transport Profile) network MN. The communication device CE2 and the communication device C2 configure an Ethernet network EN2.

The communication device PE1 is connected with the communication device CE1 and the communication device P1. In other words, the communication device PE1 is an edge device connected with the Ethernet network EN1 among the communication devices configuring the MPLS-TP network MN. Moreover, the communication device PE1 configures a MEP (Maintenance End Point).

Further, the communication device PE2 is connected with the communication device CE2 and the communication device P2. In other words, the communication device PE2 is an edge device connected with the Ethernet network EN2 among the communication devices configuring the MPLS-TP network MN. Moreover, the communication device PE2 configures a MEP.

Thus, the communication system 1 is a communication system in which the Ethernet network EN1 and the MPLS-TP network MN are connected and the Ethernet network EN2 and the MPLS-TP network MN are connected.

Further, the communication device P1 is connected with the communication device PE1 and the communication device P2. In other words, the communication device P1 is a non-edge device connected with only the communication devices configuring the MPLS-TP network MN among the communication devices configuring the MPLS-TP network MN. Moreover, the communication device P1 configures a MIP (Maintenance Intermediate Point).

Further, the communication device P2 is connected with the communication device PE2 and the communication device P1. In other words, the communication device P2 is a non-edge device connected with only the communication devices configuring the MPLS-TP network MN among the communication devices configuring the MPLS-TP network MN. Moreover, the communication device P2 configures a MIP.

Next, the configurations of the communication devices C1, CE1, PE1, P1, P2, PE2, CE2 and C2 will be described in more detail, respectively.

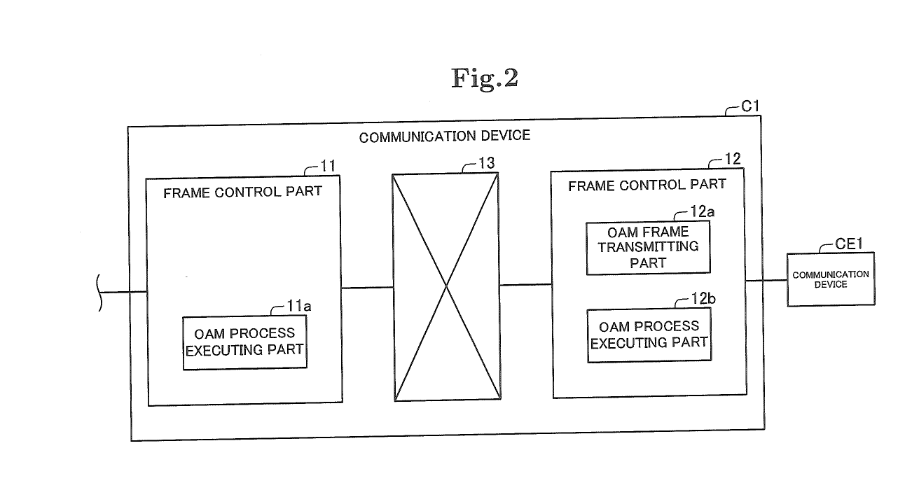

As shown in FIG. 2, the communication device C1 includes a frame control part 11, a frame control part 12, and a crossbar switch 13.

The frame control part 11 includes a port (not shown in the drawings) and is connected to a user terminal (not shown in the drawings) via the port. The frame control part 12 includes a port (not shown in the drawings) and is connected to the communication device CE1 via the port. The crossbar switch 13 connects the frame control part 11 and the frame control part 12. The communication device C1 may include a frame control part other than the frame control part 11 and the frame control part 12.

The communication device C1 relays communication between the user terminal connected to the frame control part 11 and the communication device CE1 connected to the frame control part 12.

The frame control part 11 includes an OAM (Operations, Administration and Maintenance) process executing part 11a.

When the communication device C1 receives a frame and the frame is an OAM frame, the OAM process executing part 11a determines whether the destination is the own port or not.

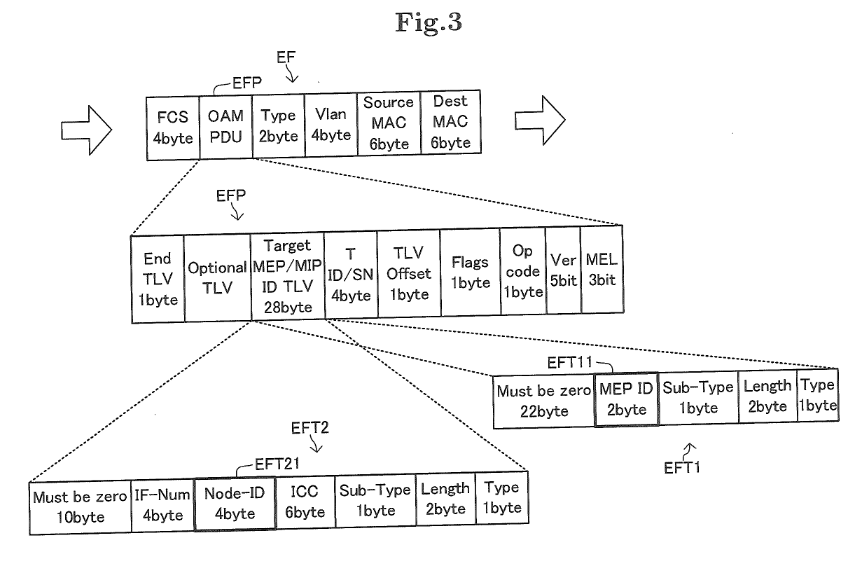

As shown in FIG. 3, an OAM frame includes Dest (Destination) MAC (Medium Access Control), Source MAC, Type, and OAM PDU (Protocol Data Unit) (EFP).

Dest MAC is a destination MAC address for specifying the destination of the frame.

Source MAC is a transmission source MAC address for specifying the transmission source of the frame.

Type is frame type information showing the type of the frame. Herein, Type is frame type information showing that the type of the frame is an OAM frame.

As shown in FIG. 3, OAM PDU (EFP) includes Op code and Target MEP/MIP ID TLV. Op code is process content information showing the content of a process. In this exemplary embodiment, Op code is process content information showing the loopback process. The loopback process is a process of sending back a frame to a communication device that is the transmission source of the frame.

Target MEP/MIP ID TLV is MPLS communication device identification information for identifying the communication device configuring the MPLS-TP network MN.

In this exemplary embodiment, in a case where the Dest MAC included in the frame agrees with the MAC address of the own port (the port included by the frame control part 11), the OAM process executing part 11a determines that the destination of the frame is the own port.

When determining that the destination of the frame is the own port, the OAM process executing part 11a executes an OAM process based on the content of a process that the process content information included by the OAM frame shows. In this exemplary embodiment, the OAM process executing part 11a executes the loopback process as the OAM process. In other words, the OAM process executing part 11a transmits a frame obtained by replacing the Source MAC with the Dest MAC in the frame received via the own port, via the own port.

The frame control part 12 includes an OAM frame transmitting part (an OAM frame transmitting means) 12a and an OAM process executing part 12b.

The OAM frame transmitting part 12a generates an OAM frame shown in FIG. 3. In a case where the destination of an OAM frame EF is MEP, OAM PDU (EFP) included by the OAM frame includes MPLS communication device identification information EFT1. The MPLS communication device identification information EFT1 includes MEP ID (EFT11). The MEP ID includes information for identifying the communication device serving as a MEP and information for identifying the port in the MPLS-TP network MN.

Further, in a case where the destination of the OAM frame EF is MIP, the OAM PDU (EFP) included by the OAM frame includes MPLS communication device identification information EFT2. The MPLS communication device identification information EFT2 includes Node-ID (EFT21), IF-Num, and ICC.

The Node-ID includes information for identifying the communication device serving as a MIP in the MPLS-TP network MN. The IF-Num includes information for identifying the port. The ICC is a carrier code defined by ITU-T (International Telecommunication Union Telecommunication Standardization Sector).

The OAM frame transmitting part 12a transmits the generated OAM frame via an own port (a port included by the frame control part 12).

Further, the OAM process executing part 12b has the same function as the OAM process executing part 11a.

Also the communication device CE1 and the communication devices CE2 and C2 configuring the Ethernet network EN1 and the Ethernet network EN2 each have the same configuration as the communication device C1.

The frame control part 11 included by the communication device CE1 includes a port (not shown in the drawings) and is connected to the communication device C1 via the port. Moreover, the frame control part 12 included by the communication device CE1 includes a port (not shown in the drawings) and is connected to the communication device PE1 via the port.

Further, the frame control part 11 included by the communication device CE2 includes a port (not shown in the drawings) and is connected to a user terminal (not shown in the drawings) via the port. Moreover, the frame control part 12 included by the communication device CE2 includes a port (not shown in the drawings) and is connected to the communication device PE2 via the port.

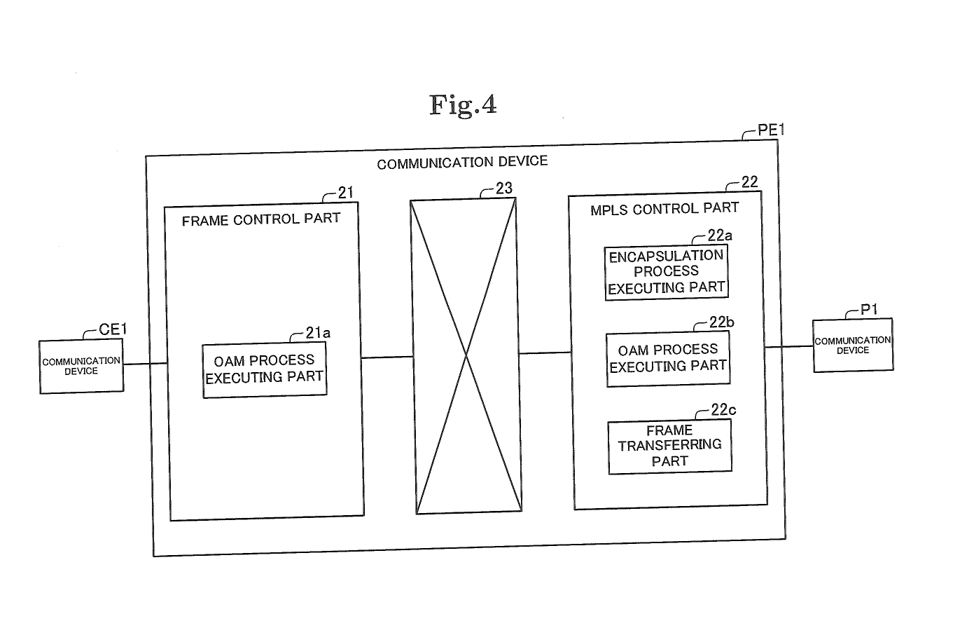

As shown in FIG. 4, the communication device PE1 includes a frame control part 21, a MPLS control part 22, and a crossbar switch 23.

The frame control part 21 includes a port (not shown in the drawings) and is connected to the communication device CE1 via the port. The MPLS control part 22 includes a port (not shown in the drawings) and is connected to the communication device P1 via the port. The crossbar switch 23 connects the frame control part 21 and the MPLS control part 22. The communication device PE1 may include a frame control part and a MPLS control part other than the frame control part 21 and the MPLS control part 22.

The communication device PE1 relays communication between the communication device CE1 connected to the frame control part 21 and the communication device P1 connected to the MPLS control part 22.

The frame control part 21 includes an OAM process executing part 21a. The OAM process executing part 21a has the same function as the OAM process executing part 11a.

The MPLS control part 22 includes an encapsulation process executing part (an encapsulation process executing means) 22a, an OAM process executing part (an OAM process executing means) 22b, and a frame transferring part (a frame transferring means) 22c.

When the communication device PE1 receives a frame (i.e., an Ethernet frame) from the Ethernet network EN1 (the communication device CE1 in this exemplary embodiment), the encapsulation process executing part 22a executes an encapsulation process of providing the frame with header information for transferring the frame through the MPLS-TP network MN.

The encapsulation process executing part 22a uses information that includes an OAM identifier, Source MAC, Type and a MPLS label, as the header information.

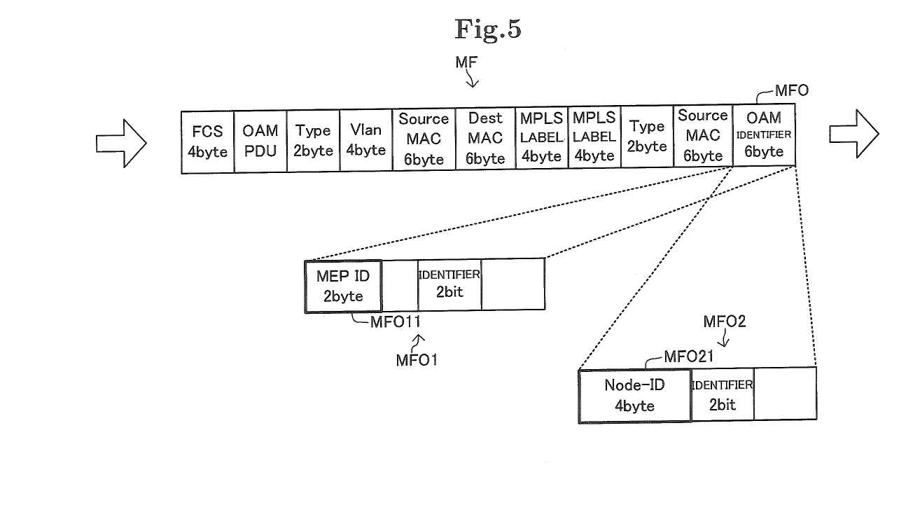

As shown in FIG. 5, in a case where a frame (i.e., an Ethernet frame) that the communication device PE1 has received from the Ethernet network EN1 (the communication device CE1 in this exemplary embodiment) is an OAM frame (i.e., frame type information included by the frame shows that the type of the frame is an OAM frame), an OAM identifier MFO includes MPLS communication device identification information included by the frame (included by OAM PDU in this exemplary embodiment).

To be specific, in a case where a communication device identified based on the MPLS communication device identification information is a MEP, an OAM identifier MFO1 includes MEP ID (MFO11) and an identifier. The identifier includes information showing whether the frame is an OAM frame or not, and information showing that the destination of the frame is either a MEP or a MIP.

Herein, the identifier includes information showing that the destination of the frame is a MEP. Moreover, the identifier includes information showing that the frame is an OAM frame when the frame is an OAM frame, whereas includes information showing that the frame is not an OAM frame when the frame is a user frame.

Further, in a case where a communication device identified based on the MPLS communication device identification information is a MIP, an OAM identifier MFO2 includes Node-ID (MFO21) and an identifier. Herein, the identifier includes information showing that the destination of the frame is a MIP.

In other words, the encapsulation process executing part 22a is configured to include an OAM identifier as a destination MAC address (i.e., include an OAM identifier instead of a destination MAC address) into header information.

Further, when the communication device PE1 receives a frame (i.e., a MPLS frame) from the MPLS-TP network MN (the communication device P1 in this exemplary embodiment), the encapsulation process executing part 22a executes a decapsulation process of eliminating header information for transferring the frame through the MPLS-TP network MN from the frame. Thus, the encapsulation process executing part 22a generates an Ethernet frame.

When the communication device PE1 receives a MPLS frame or the encapsulation process executing part 22a generates a MPLS frame, the OAM process executing part 22b determines whether the MPLS frame is an OAM frame or not. To be specific, the OAM process executing part 22b determines whether the MPLS frame is an OAM frame based on the OAM identifier included by the MPLS frame.

When the OAM process executing part 22 determines that the MPLS frame is an OAM frame and a communication device identified based on the MPLS communication device identification information included by the OAM identifier included by the header information of the MPLS frame is the own device, the OAM process executing part 22b executes the OAM process. To be specific, when a port specified by port specification information included by the MPLS frame is the own port (i.e., the port included by the MPLS control part 22), the OAM process executing part 22b executes an OAM process.

Port specification information is information for identifying a port to be subjected to an OAM process. Herein, the port specification information is MEP ID.

The OAM process is a process based on the content of a process shown by process content information included by the frame.

When the communication device PE1 has received a MPLS frame or when the encapsulation process executing part 22a has generated a MPLS frame, the frame transferring part 22c determines whether the MPLS frame is an OAM frame or not. To be specific, the frame transferring part 22c determines whether the MPLS frame is an OAM frame or not based on an OAM identifier.

When the frame transferring part 22c determines that the MPLS frame is an OAM frame and a communication device identified based on the MPLS communication device identification information included by the OAM identifier included by the header information of the MPLS frame is not the own device, the frame transferring part 22c transfers the MPLS frame to the other communication device.

Further, when determining that the MPLS frame is a user frame, the frame transferring part 22c transfers the MPLS frame to the other communication device in accordance with a MPLS label included by the header information of the MPLS frame.

The edge device PE2 configuring the MPLS-TP network MN also has the same configuration as the communication device PE 1.

The frame control part 21 included by the edge device PE2 includes a port (not shown in the drawings) and is connected to the communication device CE2 via the port. Moreover, the MPLS control part 22 included by the edge device PE2 includes a port (not shown in the drawings) and is connected to the communication device P2 via the port.

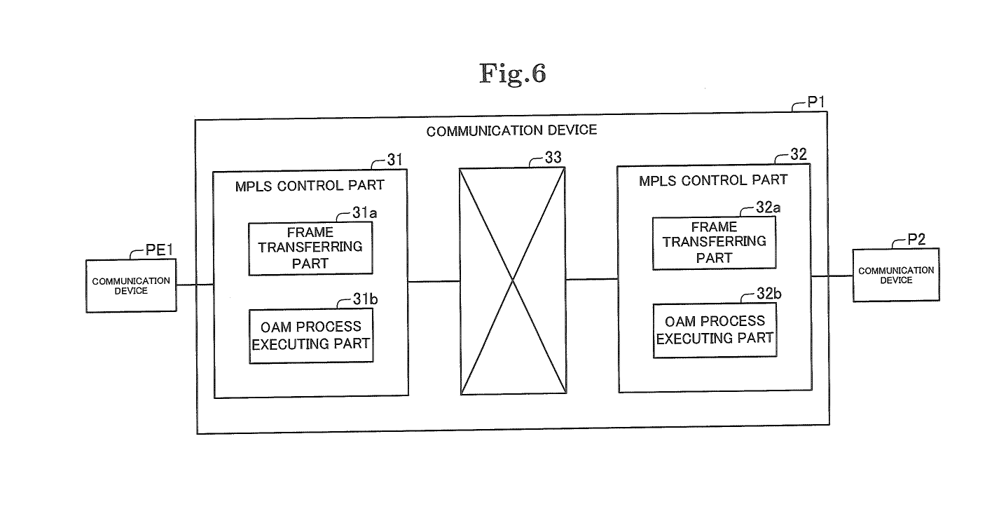

As shown in FIG. 6, the communication device P1 includes a MPLS control part 31, a MPLS control part 32, and a crossbar switch 33.

The MPLS control part 31 includes a port (now shown in the drawings) and is connected to the communication device PE1 via the port. The MPLS control part 32 includes a port (not shown in the drawings) and is connected to the communication device P2 via the port. The crossbar switch 33 connects the MPLS control part 31 and the MPLS control part 32. The communication device P1 may include a MPLS control part other than the MPLS control part 31 and the MPLS control part 32.

The communication device P1 relays communication between the communication device PE1 connected to the MPLS control part 31 and the communication device P2 connected to the MPLS control part 32.

The MPLS control part 31 includes a frame transferring part (a frame transferring means) 31a, and an OAM process executing part (an OAM process executing means) 31b.

When the communication device P1 receives a MPLS frame, the frame transferring part 31a determines whether the MPLS frame is an OAM frame or not. To be specific, the frame transferring part 31a determines whether the MPLS frame is an OAM frame or not based on an OAM identifier included by the MPLS frame.

In a case where the frame transferring part 31a determines that the MPLS frame is an OAM frame and a communication device identified based on MPLS communication device identification information included by the OAM identifier included by header information of the MPLS frame is not the own device, the frame transferring part 31a transfers the MPLS frame to the other communication device.

Further, in the case of determining that the MPLS frame is a user frame, the frame transferring part 31a transfers the MPLS frame to the other communication device in accordance with a MPLS label included by the header information of the MPLS frame.

When the communication device P1 receives a MPLS frame, the OAM process executing part 31b determines whether the MPLS frame is an OAM frame or not. To be specific, the OAM process executing part 31b determines whether the MPLS frame is an OAM frame or not based on an OAM identifier included by the MPLS frame.

In a case where the OAM process executing part 31b determines that the MPLS frame is an OAM frame and a communication device identified based on MPLS communication device identification information included by the OAM identifier included by the header information of the MPLS frame, the OAM process executing part 31b executes the OAM process. To be specific, in a case where a port specified by port specification information included by the MPLS frame is an own port (i.e., a port included by the MPLS control part 31), the OAM process executing part 31b executes an OAM process. Herein, the port specification information is IF-Num included by OAM PDU.

The MPLS control part 32 has the same function as the MPLS control part 31. In other words, the MPLS control part 32 includes a frame transferring part 32a having the same function as the frame transferring part 31, and an OAM process executing part 32b having the same function as the OAM process executing part 31b.

Further, the non-edge device P2 configuring the MPLS-TP network MN also has the same configuration as the communication device P1.

The MPLS control part 31 included by the non-edge device P2 includes a port (not shown in the drawings) and is connected to the communication device PE2 via the port. Moreover, the MPLS control part 32 included by the non-edge device P2 includes a port (not shown in the drawings) and is connected to the communication device P1 via the port.

### Operation

Next, an operation of the above communication system 1 will be described.

First, it is assumed that the communication device C1 transmits a user frame toward the communication device C2. In this case, the user frame transmitted by the communication device C1 is received by the communication device PE1 through the communication device CE1.

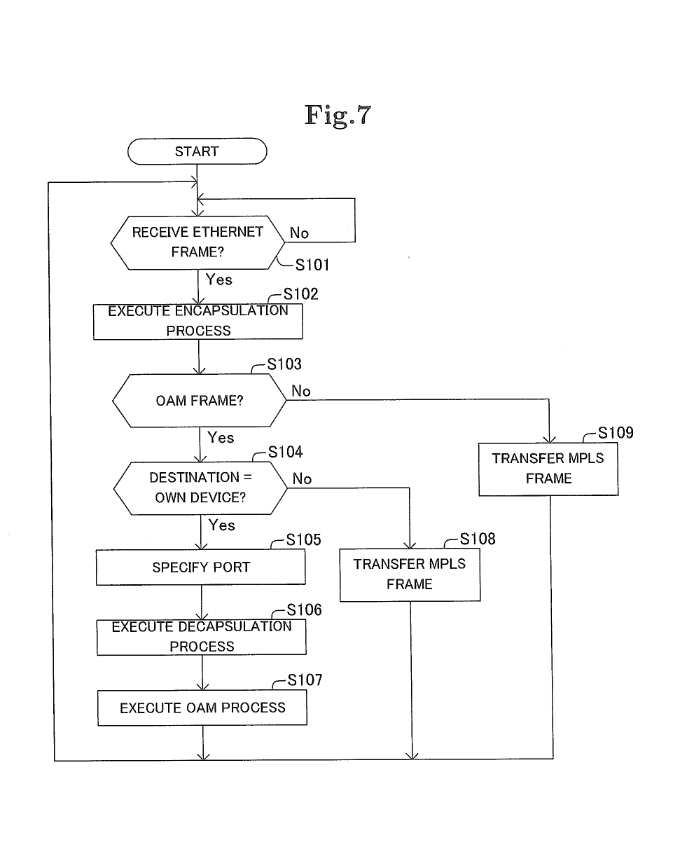

The communication device PE1 is configured to execute a process shown by a flowchart in FIG. 7. To be specific, after starting the process shown in FIG. 7, the communication device PE1 stands by in step S101 until receiving an Ethernet frame.

According to the above assumption, the communication device PE1 receives an Ethernet frame. Therefore, the communication device PE1 determines “Yes” and proceeds to step S102 to execute the encapsulation process (step S102).

In this case, frame type information included by the Ethernet frame shows that the type of the frame is a user frame other than an OAM frame. Therefore, the communication device PE1 executes the encapsulation process to provide the Ethernet frame with header information that includes an OAM identifier showing that the frame is not an OAM frame, Source MAC, Type, and a MPLS label. Thus, the communication device PE1 generates a MPLS frame.

Next, the communication device PE1 determines whether the generated MPLS frame is an OAM frame or not (step S103). In this case, the OAM identifier included by the OAM frame shows that the frame is not an OAM frame.

Therefore, the communication device PE1 determines “No” and proceeds to step S109 to transfer (transmit) the MPLS frame to the other communication device (in this case, the communication device P1) in accordance with the MPLS label included by the header information.

After that, the communication device PE1 returns to step S101 and repeats execution of the process from step S101 to step S109.

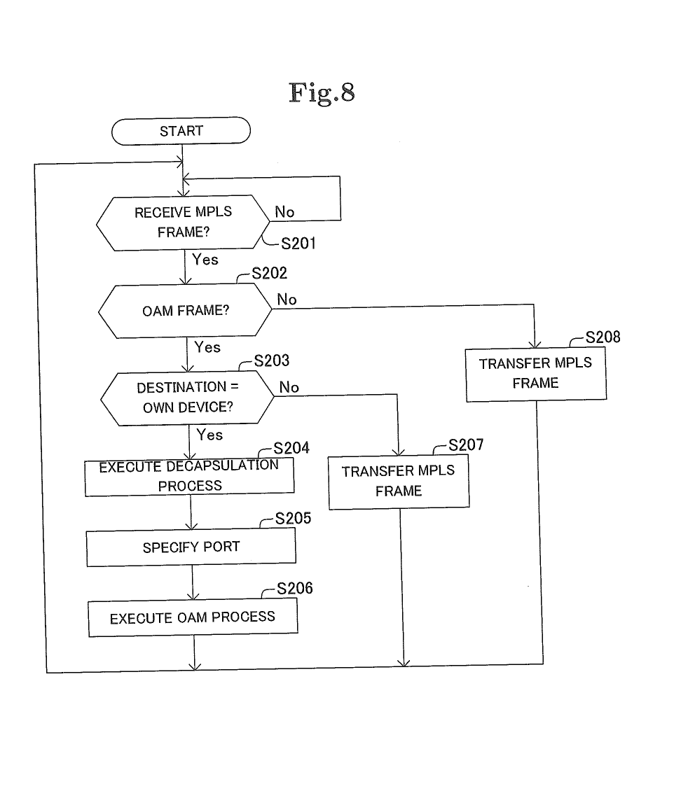

On the other hand, the communication device P1 is configured to execute a process shown by a flowchart in FIG. 8. To be specific, after starting the process shown in FIG. 8, the communication device P1 stands by in step S201 until receiving a MPLS frame.

According to the assumption, the communication device P1 receives the MPLS frame. Therefore, the communication device P1 determines “Yes” and proceeds to step S202 to determine whether the received MPLS frame is an OAM frame or not. In this case, the OAM identifier included by the OAM frame shows that the frame is not an OAM frame.

Therefore, the communication device P1 determines “No” and proceeds to step S208 to transfer the MPLS frame to the other communication device (in this case, the communication device P2) in accordance with the MPLS label included by the header information.

After that, the communication device P1 returns to step S201, and repeats execution of the process from step S201 to step S208.

Further, the communication device P2 executes the process shown by the flowchart in FIG. 8 in the same manner as the communication device P1. Therefore, when receiving the MPLS frame from the communication device P1, the communication device P2 transfers the MPLS frame to the other communication device (in this case, the communication device PE2) in accordance with the MPLS label included by the header information, in the same manner as the communication device P1.

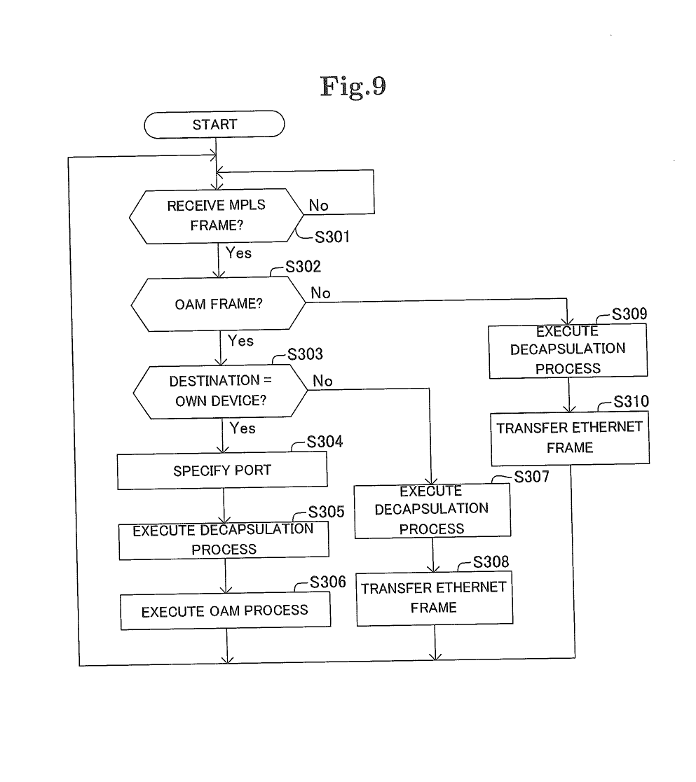

On the other hand, the communication device PE2 is configured to execute a process shown by a flowchart in FIG. 9. To be specific, after starting the process shown in FIG. 9, the communication device PE2 stands by in step S301 until receiving a MPLS frame.

According to the assumption, the communication device PE2 receives the MPLS frame. Therefore, the communication device PE2 determines “Yes” and proceeds to step S302 to determine whether the received MPLS frame is an OAM frame or not. Herein, the OAM identifier included by the OAM frame shows that the frame is not an OAM frame.

Therefore, the communication device PE2 determines “No” and proceeds to step S309 to execute a decapsulation process of eliminating the header information for transferring the frame through the MPLS-TP network MN from the MPLS frame. Thus, the communication device PE2 generates the Ethernet frame.

Next, the communication device PE2 transfers the generated Ethernet frame to the communication device CE2 (step S310).

After that, the communication device PE2 returns to step S301 and repeats execution of the process from step S301 to step S310.

The communication device CE2 transfers the Ethernet frame received from the communication device PE2 to the communication device C2. Thus, the communication device C2 receives the Ethernet frame transmitted by the communication device C1.

Next, it is assumed that the communication device C1 transmits an OAM frame (an Ethernet frame) to the port included by the MPLS control part 22 of the communication device PE 1. In other words, this OAM frame includes MEP ID for specifying the port included by the MPLS control part 22 of the communication device PE1.

In this case, the OAM frame transmitted by the communication device C1 is received by the communication device PE1 through the communication device CE1.

Therefore, when receiving the Ethernet frame, the communication device PE1 determines “Yes” in step S101 of FIG. 7, and proceeds to step S102 to execute the encapsulation process (step S102).

In this case, frame type information included by the Ethernet frame shows that the type of the frame is an OAM frame. Therefore, the communication device PE1 executes the encapsulation process to provide the Ethernet frame with header information that includes an OAM identifier including an identifier showing that the frame is an OAM frame and MEP ID for identifying the communication device PE1 and specifying the port, Source MAC, Type, and MPLS label. Thus, the communication device PE1 generates a MPLS frame.

Next, the communication device PE1 determines whether the generated MPLS frame is an OAM frame or not (step S103). In this case, the OAM identifier included by the OAM frame shows that the frame is an OAM frame.

Therefore, the communication device PE1 determines “Yes” and proceeds to step S104 to determine whether the destination is the device itself or not. To be specific, the communication device PE1 determines whether the destination is the device itself or not based on the OAM identifier included by the header information of the MPLS frame.

In this case, the OAM identifier includes the MEP ID for identifying the communication device PE1 and specifying the port included by the MPLS control part 22 of the communication device PE1. Therefore, the communication device PE1 determines “Yes” and proceeds to step S105 to specify the port to be subjected to an OAM process. In this case, the communication device PE1 specifies the port based on the MEP ID included by the header information of the MPLS frame.

Then, the communication device PE1 executes the decapsulation process of eliminating the header information for transferring the frame through the MPLS-TP network MN from the MPLS frame (step S106). Thus, the communication device PE1 generates the Ethernet frame.

Next, the communication device PE1 executes an OAM process based on the content of a process shown by process content information included by the generated Ethernet frame, on the specified port (step S107). In this example, the communication device PE1 executes the loopback process on the port included by the MPLS control part 22 of the communication device PE1.

Thus, the communication device PE1 sends back the OAM frame, which is the Ethernet frame, to the communication device C1.

After that, the communication device PE 1 returns to step S101 and repeats execution of the process from step S101 to step S109.

Next, it is assumed that the communication device C1 transmits an OAM frame (an Ethernet frame) to the port included by the MPLS control part 31 of the communication device P1. In other words, this OAM frame includes Node-ID for identifying the communication device P1, and IF-Num for specifying the port included by the MPLS control part 31 of the communication device P1.

In this case, the OAM frame transmitted by the communication device C1 is received by the communication device PE1 through the communication device CE 1.

Therefore, when receiving the Ethernet frame, the communication device PE1 determines “Yes” in step S101 of FIG. 7, and proceeds to step S102 to execute the encapsulation process (step S102).

In this case, frame type information included by the Ethernet frame shows that the type of the frame is an OAM frame. Therefore, the communication device PE1 executes the encapsulation process to provide the Ethernet frame with header information that includes an OAM identifier including an identifier showing that the frame is an OAM frame and Node-ID for identifying the communication device P1, Source MAC, Type, and a MPLS label. Thus, the communication device PE1 generates a MPLS frame.

Next, the communication device PE1 determines whether the generated MPLS frame is an OAM frame or not (step S103). In this case, the OAM identifier included by the OAM frame shows that the frame is an OAM frame.

Therefore, the communication device PE1 determines “Yes” and proceeds to step S104 to determine whether the destination is the device itself or not. To be specific, the communication device PE1 determines whether the destination is the device itself or not based on the OAM identifier included by the header information of the MPLS frame.

In this case, the OAM identifier includes the Node-ID for identifying the communication device P1. Therefore, the communication device PE1 determines “No” and proceeds to step S108 to transfer (transmit) the MPLS frame to the other communication device (in this case, the communication device P1) in accordance with the MPLS label included by the header information.

After that, the communication device PE1 returns to step S101 and repeats execution of the process from step S101 to step S109.

At this point in time, the MPLS frame (the OAM frame) transmitted by the communication device PE1 is received by the communication device P1.

Therefore, when receiving the MPLS frame, the communication device P1 determines “Yes” in step S201 of FIG. 8, and proceeds to step S202 to determine whether the received MPLS frame is an OAM frame or not. In this case, the OAM identifier included in the OAM frame shows that the frame is an OAM frame.

Therefore, the communication device P1 determines “Yes” and proceeds to step S203 to determine whether the destination is the device itself or not. To be specific, the communication device P1 determines whether the destination is the device itself or not based on the OAM identifier included by the header information of the MPLS frame.

In this case, the OAM identifier includes the Node-ID for identifying the communication device P1. Therefore, the communication device P1 determines “Yes” and proceeds to step S204 to execute the decapsulation process of eliminating the header information for transferring the frame through the MPLS-TP network MN from the MPLS frame. Thus, the communication device P1 generates the Ethernet frame.

Next, the communication device P1 specifies a port to be subjected to an OAM process (step S205). In this case, the communication device P1 specifies the port based on the IF-Num included by the Ethernet frame generated by execution of the decapsulation process.

In a case where ICC associated with the specified port agrees with ICC included in the Ethernet frame generated by execution of the decapsulation process, the communication device P1 executes an OAM process on the specified port (step S206). This OAM process is a process based on the content of a process shown by process content information included by the Ethernet frame generated by execution of the decapsulation process. In this example, the communication device P1 executes the loopback process on the port included by the MPLS control part 31 of the communication device P1.

Thus, the communication device P1 sends back the OAM frame toward the communication device C1.

After that, the communication device P1 returns to step S201 and repeats execution of the process from step S201 to step S208.

Next, it is assumed that the communication device C1 transmits an OAM frame (an Ethernet frame) to the port included by the MPLS control part 32 of the communication device P1. In other words, this OAM frame includes Node-ID for identifying the communication device P1, and IF-Num for specifying the port included by the MPLS control part 32 of the communication device P1.

In this case, the communication system 1 operates in the same manner as described above. Thus, the communication device P1 executes the loopback process on the port included by the MPLS control part 32 of the communication device P1. In this example, the communication device P1 sends back the OAM frame toward the communication device C1.

Next, it is assumed that the communication device C1 transmits an OAM frame (an Ethernet frame) to the port included by the MPLS control part 31 of the communication device P2. In other words, this OAM frame includes Node-ID for identifying the communication device P2, and IF-Num for specifying the port included by the MPLS control part 31 of the communication device P2.

In this case, the OAM frame transmitted by the communication device C1 is received by the communication device P1 through the communication device CE1 and the communication device PE1.

Therefore, when receiving a MPLS frame, the communication device P1 determines “Yes” in step S201 of FIG. 8, and proceeds to step S202 to determine whether the received MPLS frame is an OAM frame or not. In this case, an OAM identifier included in the OAM frame shows that the frame is an OAM frame.

Therefore, the communication device P1 determines “Yes” and proceeds to step S203 to determine whether the destination is the device itself or not. To be specific, the communication device P1 determines whether the destination is the device itself or not based on the OAM identifier included by header information of the MPLS frame.

In this case, the OAM identifier includes the Node-ID for identifying the communication device P2. Therefore, the communication device P1 determines “No” and proceeds to step S207 to transfer the MPLS frame to the other communication device (in this case, the communication device P2) in accordance with a MPLS label included by the header information.

After that, the communication device P1 returns to step S201 and repeats execution of the process from step S201 to step S208.

Thus, the communication device P2 receives the MPLS frame (the OAM frame) from the communication device P1. Therefore, at this point in time, the communication device P2 determines “Yes” in each of steps S201 to S203 and executes the process from step S204 to step S206.

Thus, the communication device P2 executes the loopback process on the port included by the MPLS control part 31 of the communication device P2. Thus, the communication device P2 sends back the OAM frame toward the communication device C1.

In a case where the communication device C1 transmits an OAM frame (an Ethernet frame) to the port included by the MPLS control part 32 of the communication device P2, the communication system 1 operates in the same manner as described above.

Next, it is assumed that the communication device C1 transmits an OAM frame (an Ethernet frame) to the port included by the MPLS control part 22 of the communication device PE2. In other words, this OAM frame includes MEP ID for identifying the communication device PE2 and specifying the port included by the MPLS control part 22 of the communication device PE2.

In this case, the OAM frame transmitted by the communication device C1 is received by the communication device PE2 through the communication device CE1, the communication device PE1, the communication device P1, and the communication device P2.

Therefore, when receiving a MPLS frame, the communication device PE2 determines “Yes in step S301 of FIG. 9, and proceeds to step S302 to determine whether the received MPLS frame is an OAM frame or not. In this case, an OAM identifier included in the OAM frame shows that the frame is an OAM frame.

Therefore, the communication device PE2 determines “Yes” and proceeds to step S303 to determine whether the destination is the device itself or not. To be specific, the communication device PE2 determines whether the destination is the device itself or not based on the OAM identifier included by header information of the MPLS frame.

In this case, the OAM identifier includes the MEP ID for identifying the communication device PE2 and specifying the port included by the MPLS control part 22 of the communication device PE2. Therefore, the communication device PE2 determines “Yes” and proceeds to step S304 to specify a port to be subjected to an OAM process. In this case, the communication device PE2 specifies the port based on the MEP ID included by the header information of the MPLS frame.

Then, the communication device PE2 executes the decapsulation process of eliminating the header information for transferring the frame through the MPLS-TP network MN from the MPLS frame (step S305). Thus, the communication device PE2 generates the Ethernet frame.

Next, the communication device PE2 executes an OAM process based on the content of a process shown by process content information included by the generated Ethernet frame, on the specified port (step S306). In this example, the communication device PE2 executes the loopback process on the port included by the MPLS control part 22 of the communication device PE2.

Thus, the communication device PE2 sends back the OAM frame, which is the MPLS frame, toward the communication device C1.

After that, the communication device PE2 returns to step S301 and repeats execution of the process from step S301 to step S310.

When the communication device C1 transmits an OAM frame (an Ethernet frame) to the port included by the frame control part 21 of the communication device PE2, the communication system 1 operates in the same manner as described above. Thus, the communication device PE2 executes the loopback process on the port included by the frame control part 21 of the communication device PE2. In this example, the communication device PE2 sends back the OAM frame toward the communication device C1.

Next, it is assumed that the communication device C1 transmits an OAM frame (an Ethernet frame) to the port included by the frame control part 12 of the communication device CE2. In this case, the communication device PE2 determines “No” in step S303 of FIG. 9, and proceeds to step S307.

Then, the communication device PE2 executes the decapsulation process of eliminating header information for transferring the frame through the MPLS-TP network MN from a MPLS frame. Thus, the communication device PE2 generates the Ethernet frame.

Next, the communication device PE2 transfers the generated Ethernet frame to the communication device CE2 (step S308).

After that, the communication device PE2 returns to step S301 and repeats execution of the process from step S301 to step S310.

After that, the communication device CE2 executes the loopback process on the port included by the frame control part 12 of the communication device CE2. Thus, the communication device CE2 sends back the OAM frame toward the communication device C1.

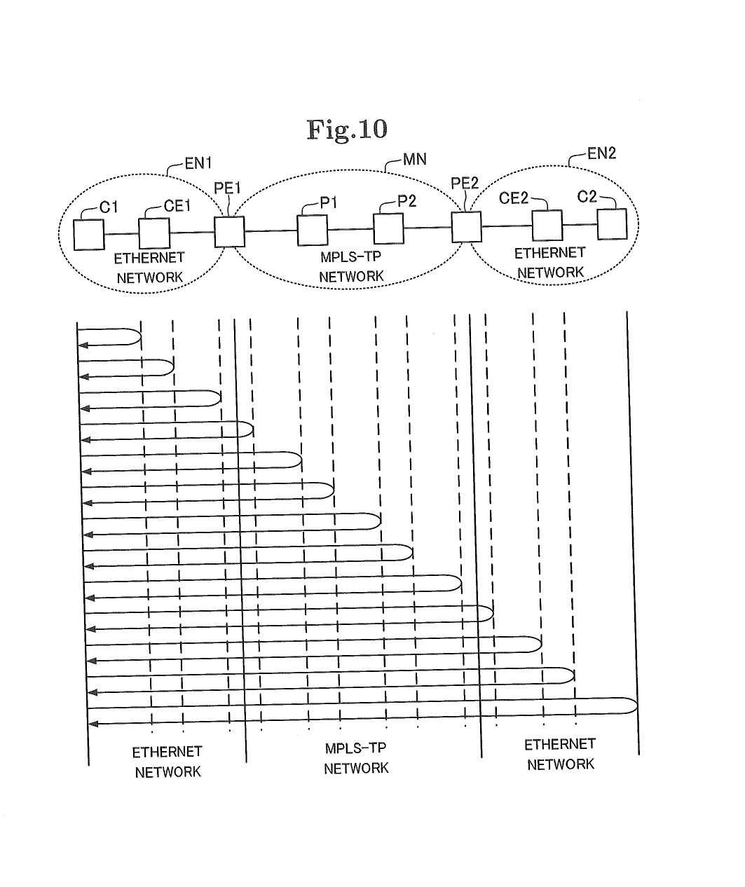

In the above manner, according to the communication system 1, it is possible to, based on an OAM frame transmitted by the communication device C1, cause each of the other communication devices CE1, PE1, P1, P2, PE2, CE2 and C2 configuring the communication system 1 to execute an OAM process on each of the ports included by the communication device as shown in FIG. 10.

In this exemplary embodiment, based on an OAM frame transmitted by the communication device C1 configuring the Ethernet network EN1, it is possible to cause each of the communication devices PE1, P1, P2 and PE2 configuring the MPLS-TP network MN to execute the loopback process as the OAM process.

As described above, according to the communication system 1 of the first exemplary embodiment of the present invention, the edge device PE1 can transfer an OAM frame received from the Ethernet network EN1 to the communication devices P1, P2 and PE2 configuring the MPLS-TP network MN, without converting MPLS communication device identification information included in the OAM frame into a TTL value. Consequently, the edge device PE1 does not need to store a table in which MPLS communication device identification information is associated with a TTL value. As a result, it is possible to reduce the cost of producing the communication system 1 and the cost of operating the communication system 1.

Further, in the communication system 1, header information of an OAM frame includes MPLS communication device identification information in the MPLS-TP network MN. Therefore, the communication devices PE1, P1, P2 and PE2 configuring the MPLS-TP network MN can determine whether to transfer an OAM frame or not without executing the decapsulation process of eliminating header information for transferring the frame through the MPLS-TP network MN on the OAM frame.

In the communication system 1 according to the first exemplary embodiment, each of the communication devices PE1, P1, P2 and PE2 configuring the MPLS-TP network MN configures a MEP or a MIP. However, part of the communication devices PE1, P1, P2 and PE2 configuring the MPLS-TP network MN may not configure either a MEP or a MIP.

Further, in the communication system 1 according to the first exemplary embodiment, only the frame control part 12 of the communication device C1 includes the OAM frame transmitting part 12a, but the frame control part 11 may also include an OAM frame transmitting part.

In the communication system 1 according to the first exemplary embodiment, the communication device configuring a MIP is configured to execute an OAM process by specifying a port based on an OAM frame whose destination is the device itself and causing only the MPLS control part associated with the specified port to execute the decapsulation process.

In the communication system 1 according to a modified example of the first exemplary embodiment, the communication device configuring a MIP is configured to cause each of the MPLS control parts to execute the decapsulation process on an OAM frame whose destination is the device itself. Moreover, each of the MPLS control parts is configured to execute an OAM process in a case where a MIP value (Node-ID, IF-Num, and ICC) associated with the MPLS control part agrees with a MIP value included in the OAM frame.

The communication system 1 configured as described above can also achieve the same actions and effects as the communication system 1 according to the first exemplary embodiment.

### Second Exemplary Embodiment

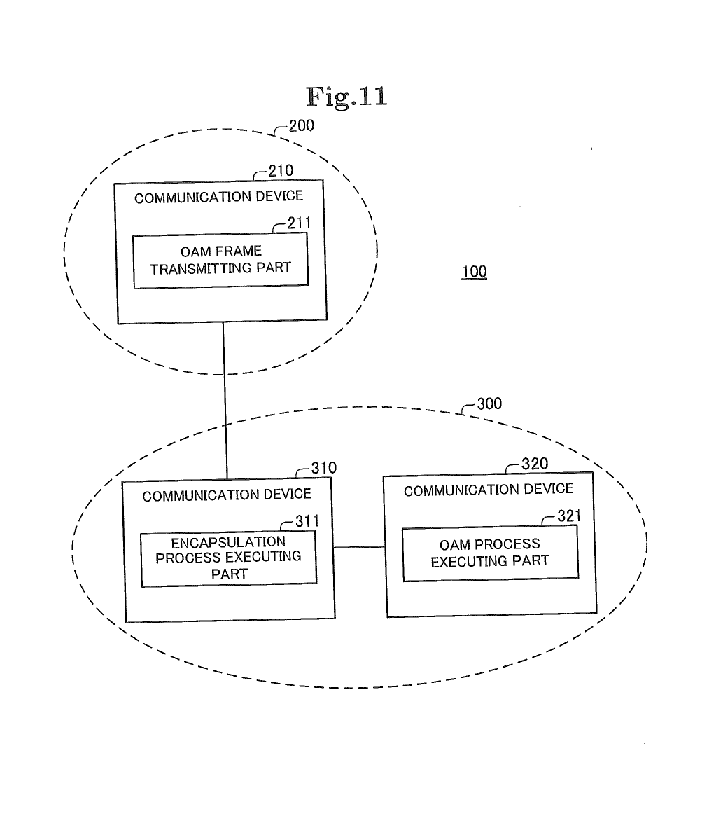

Next, a communication system according to a second exemplary embodiment of the present invention will be described referring to FIG. 11.

A communication system 100 according to the second exemplary embodiment is a system in which an Ethernet™ network 200 and a MPLS-TP (Multi Protocol Label Switching Transport Profile) network 300 are connected with each other.

A communication device 210 configuring the Ethernet network 200 includes an OAM frame transmitting part (an OAM frame transmitting means) 211 for transmitting an OAM frame that includes frame type information showing that a frame type is an OAM (Operations, Administration and Maintenance) frame, MPLS communication device identification information for identifying a communication device configuring the MPLS-TP network, and process content information showing a content of a process.

An edge device 310, which is a communication device connected with the Ethernet network 200 among communication devices configuring the MPLS-TP network 300, includes an encapsulation process executing part (an encapsulation process executing means) 311 for, when the edge device receives a frame from the Ethernet network 200, executing an encapsulation process of providing the frame with header information for transferring the frame through the MPLS-TP network 300.

The encapsulation process executing part 311 is configured to, in a case where frame type information included by the received frame shows that a frame type is an OAM frame, provide the frame with header information including an OAM identifier including MPLS communication device identification information included by the frame.

A communication device 320 configuring the MPLS-TP network 300 includes an OAM process executing part (an OAM process executing means) 321 for, when the communication device receives a frame and in a case where header information of the frame includes an OAM identifier and a communication device identified based on MPLS communication device identification information included by the OAM identifier is the device itself, executing an OAM process based on a content of a process shown by process content information included by the frame.

According to this, the edge device 310 can transfer an OAM frame received from the Ethernet network 200 to each of the communication devices 310 and 320 configuring the MPLS-TP network 300, without converting MPLS communication device identification information included in the OAM frame into a TTL value. Consequently, the edge device 310 does not need to store a table in which MPLS communication device identification information and a TTL value are associated with each other. As a result, it is possible to reduce the cost of producing the communication system 100 and the cost of operating the communication system 100.

Further, according to the communication system 100, in the MPLS-TP network 300, header information of an OAM frame includes MPLS communication device identification information. Therefore, the communication devices 310 and 320 configuring the MPLS-TP network 300 can each determine whether to transfer an OAM frame without executing, on the OAM frame, the decapsulation process of eliminating header information for transferring the frame through the MPLS-TP network 300. As a result, it is also possible to transfer a frame at relatively high speeds through the MPLS-TP network 300.

Although the present invention is described above referring to the exemplary embodiments, the present invention is not limited to the exemplary embodiments described above. The configurations and details of the present invention can be modified in various manners that can be understood by one skilled in the art within the scope of the present invention.

Each function of the communication device in the respective exemplary embodiments described above is realized by hardware such as a circuit. However, the communication device may include a processing device and a storage device that stores a program (software), and may be configured to realize each function by execution of the program by the processing device. In this case, the program may be stored on a computer-readable recording medium. For example, the recording medium is a portable medium such as a flexible disk, an optical disk, a magneto-optical disk, and a semiconductor memory.

Further, as another modified example of the exemplary embodiments described above, any combination of the abovementioned exemplary embodiments and modified examples may be employed.

### Supplementary Notes

The whole or part of the exemplary embodiments disclosed above can be described as, but not limited to, the following supplementary notes.

### (Supplementary Note 1)

A communication system in which an Ethernet™ network and a MPLS-TP (Multi Protocol Label Switching Transport Profile) network are connected with each other, wherein:

a communication device configuring the Ethernet network comprises an OAM frame transmitting means for transmitting an OAM frame that includes frame type information showing that a frame type is an OAM (Operations, Administration and Maintenance) frame, MPLS communication device identification information for identifying a communication device configuring the MPLS-TP network, and process content information showing a content of a process;

an edge device, which is a communication device connected with the Ethernet network among communication devices configuring the MPLS-TP network, comprises an encapsulation process executing means for, when the edge device receives a frame from the Ethernet network, executing an encapsulation process of providing the frame with header information for transferring the frame through the MPLS-TP network;

the encapsulation process executing means is configured to, in a case where frame type information included by the received frame shows that a frame type is an OAM frame, provide the frame with header information including an OAM identifier including MPLS communication device identification information included by the frame; and

the communication device configuring the MPLS-TP network comprises an OAM process executing means for, when the communication device receives a frame and in a case where header information of the frame includes an OAM identifier and a communication device identified based on MPLS communication device identification information included by the OAM identifier is the device itself, executing an OAM process based on a content of a process shown by process content information included by the frame.

According to this, the edge device can transfer an OAM frame received from the Ethernet network to the communication device configuring the MPLS-TP network without converting MPLS communication device identification information included by the OAM frame into a TTL value. Consequently, the edge device does not need to store a table in which MPLS communication device identification information are associated with a TTL value. As a result, it is possible to reduce the cost of producing a communication system and the cost of operating a communication system.

Further, according to the communication system, header information of an OAM frame includes MPLS communication device identification information in the MPLS-TP network. Therefore, the communication device configuring the MPLS-TP network can determine whether to transfer an OAM frame without executing, on the OAM frame, a decapsulation process of eliminating header information for transferring the frame through the MPLS-TP network. As a result, it is also possible to transfer a frame at relatively high speeds through the MPLS-TP network.

### (Supplementary Note 2)

The communication system according to Supplementary Note 1, wherein the communication device configuring the MPLS-TP network comprises a frame transferring means for, when the communication device receives a frame and in a case where header information of the frame includes an OAM identifier and a communication device identified based on MPLS communication device identification information included by the OAM identifier is not the device itself, transferring the frame.

### (Supplementary Note 3)

The communication system according to Supplementary Note 1 or 2, wherein the encapsulation process executing means is configured to include the OAM identifier as a destination MAC (Medium Access Control) address into the header information.

### (Supplementary Note 4)

The communication system according to any of Supplementary Notes 1 to 3, wherein:

the frame includes port specification information for specifying a port to be subjected to the OAM process; and

the OAM process executing means is configured to execute the OAM process on the port specified based on the port specification information.

### (Supplementary Note 5)

The communication system according to any of Supplementary Notes 1 to 4, wherein the MPLS communication device identification information includes MEP ID in a case where the communication device identified based on the MPLS communication device identification information is a MEP (Maintenance End Point) serving as an edge device that is a communication device connected with a communication network other than the MPLS-TP network among the communication devices configuring the MPLS-TP network.

### (Supplementary Note 6)

The communication system according to any of Supplementary Notes 1 to 5, wherein the MPLS communication device identification information includes Node-ID in a case where the communication device identified based on the MPLS communication device identification information is a MIP (Maintenance Intermediate Point) serving as a non-edge device that is a communication device connected with only the communication device configuring the MPLS-TP network among the communication devices configuring the MPLS-TP network.

### (Supplementary Note 7)

The communication system according to any of Supplementary Notes 1 to 6, wherein the OAM process is a loopback process of sending back the frame to a communication device that is a transmission source of the frame.

### (Supplementary Note 8)

A communication method applied to a communication system in which an Ethernet™ network and a MPLS-TP (Multi Protocol Label Switching Transport Profile) network are connected with each other, the communication method comprising:

transmitting an OAM frame that includes frame type information showing that a frame type is an OAM (Operations, Administration and Maintenance) frame, MPLS communication device identification information for identifying a communication device configuring the MPLS-TP network, and process content information showing a content of a process, by a communication device configuring the Ethernet network; and

executing an encapsulation process of providing a frame with header information for transferring the frame through the MPLS-TP network when an edge device, which is a communication device connected with the Ethernet network among communication devices configuring the MPLS-TP network, receives the frame from the Ethernet network, by the edge device,

wherein the encapsulation process is configured to, in a case where frame type information included by the received frame shows that a frame type is an OAM frame, provide the frame with header information including an OAM identifier including MPLS communication device identification information included by the frame,

the communication method further comprising:

executing an OAM process based on a content of a process shown by process content information included by a frame when the communication device configuring the MPLS-TP network receives the frame and in a case where header information of the frame includes an OAM identifier and a communication device identified based on MPLS communication device identification information included by the OAM identifier is the device itself, by the communication device.

### (Supplementary Note 9)

The communication method according to Supplementary Note 8, comprising transferring a frame when the communication device configuring the MPLS-TP network receives the frame and in a case where header information of the frame includes an OAM identifier and a communication device identified based on MPLS communication device identification information included by the OAM identifier is not the device itself, by the communication device.

### (Supplementary Note 10)

The communication method according to Supplementary Note 8 or 9, comprising including the OAM identifier as a destination MAC (Medium Access Control) address into the header information in the encapsulation process.

### (Supplementary Note 11)

An edge device as a communication device connected with an Ethernet™ network among communication devices configuring a MPLS-TP (Multi Protocol Label Switching Transport Profile) network,

the edge device comprising an encapsulation process executing means for, when the edge device receives a frame from the Ethernet network, executing an encapsulation process of providing the frame with header information for transferring the frame through the MPLS-TP network,

wherein the encapsulation process executing means is configured to, in a case where frame type information included by the received frame shows that a frame type is an OAM (Operations, Administration and Maintenance) frame, provide the frame with header information including an OAM identifier including MPLS communication device identification information for identifying a communication device configuring the MPLS-TP network, the MPLS communication device identification information being included by the frame,

the edge device further comprising an OAM process executing means for, when the edge device receives a frame and in a case where header information of the frame includes an OAM identifier and a communication device identified based on MPLS communication device identification information included by the OAM identifier is the device itself, executing an OAM process based on a content of a process shown by process content information included by the frame.

### (Supplementary Note 12)

The edge device according to Supplementary note 11, comprising a frame transferring means for, when the edge device receives a frame and in a case where header information of the frame includes an OAM identifier and a communication device identified based on MPLS communication device identification information included by the OAM identifier is not the device itself, transferring the frame.

### (Supplementary Note 13)

The edge device according to Supplementary note 11 or 12, wherein the encapsulation process executing means is configured to include the OAM identifier as a destination MAC (Medium Access Control) address into the header information.

### (Supplementary Note 14)

An edge device control method applied to an edge device, which is a communication device connected with an Ethernet™ network among communication devices configuring a MPLS-TP (Multi Protocol Label Switching Transport Profile) network,

the edge device control method comprising executing an encapsulation process of providing a frame with header information for transferring the frame through the MPLS-TP network when the edge device receives the frame from the Ethernet network,

wherein the encapsulation process is configured to, in a case where frame type information included by the received frame shows that a frame type is an OAM (Operations, Administration and Maintenance) frame, provide the frame with header information including an OAM identifier including MPLS communication device identification information for identifying a communication device configuring the MPLS-TP network, the MPLS communication device identification information being included by the frame,

the edge device control method further comprising executing an OAM process based on a content of a process shown by process content information included by a frame when the edge device receives the frame and in a case where header information of the frame includes an OAM identifier and a communication device identified based on MPLS communication device identification info nation included by the OAM identifier is the device itself.

### (Supplementary Note 15)

The edge device control method according to Supplementary Note 14, comprising transferring a frame when the edge device receives the frame and in a case where header information of the frame includes an OAM identifier and a communication device identified based on MPLS communication device identification information included by the OAM identifier is not the device itself.

### (Supplementary Note 16)

The edge device control method according to Supplementary Note 14 or 15, comprising including the OAM identifier as a destination MAC (Medium Access Control) address into the header information in the encapsulation process.

### (Supplementary Note 17)

An edge device control program executed by an edge device, which is a communication device connected with an Ethernet™ network among communication devices configuring a MPLS-TP (Multi Protocol Label Switching Transport Profile) network,

the edge device control program comprising instructions for causing the edge device to execute an encapsulation process of providing a frame with header information for transferring the frame through the MPLS-TP network when the edge device receives the frame from the Ethernet network,

wherein the encapsulation process is configured to, in a case where frame type information included by the received frame shows that a frame type is an OAM (Operations, Administration and Maintenance) frame, provide the frame with header information including an OAM identifier including MPLS communication device identification information for identifying a communication device configuring the MPLS-TP network, the MPLS communication device identification information being included by the frame,

the edge device control program further comprising instructions for causing the edge device to execute an OAM process based on a content of a process shown by process content information included by a frame when the edge device receives the frame and in a case where header information of the frame includes an OAM identifier and a communication device identified based on MPLS communication device identification information included by the OAM identifier is the device itself.

### (Supplementary Note 18)

The edge device control program according to Supplementary Note 17, comprising instructions for causing the edge device to transfer a frame when the edge device receives the frame and in a case where header information of the frame includes an OAM identifier and a communication device identified based on MPLS communication device identification information included by the OAM identifier is not the device itself.

### (Supplementary Note 19)

The edge device control program according to Supplementary Note 17 or 18, comprising instructions for causing the edge device to include the OAM identifier as a destination MAC (Medium Access Control) address into the header information in the encapsulation process.

### (Supplementary Note 20)

A non-edge device as a communication device connected with only a communication device configuring a MPLS-TP (Multi Protocol Label Switching Transport Profile) network, among communication devices configuring the MPLS-TP network,

the non-edge device comprising an OAM (Operations, Administration and Maintenance) process executing means for, when the non-edge device receives a frame and in a case where header information of the frame includes an OAM identifier and a communication device identified based on MPLS communication device identification information that is for identifying the communication device configuring the MPLS-TP network and that is included by the OAM identifier is the device itself, executing an OAM process based on a content of a process shown by process content information included by the frame.

### (Supplementary Note 21)

The non-edge device according to Supplementary Note 20, comprising a frame transferring means for, when the non-edge device receives a frame and in a case where header information of the frame includes an OAM identifier and a communication device identified based on MPLS communication device identification information included by the OAM identifier is not the device itself, transferring the frame.

### (Supplementary Note 22)

The non-edge device according to Supplementary Note 20 or 21, wherein the OAM identifier is included as a destination MAC (Medium Access Control) address into the header information.

### (Supplementary Note 23)

A non-edge device control method applied to a non-edge device, which is a communication device connected with only a communication device configuring a MPLS-TP (Multi Protocol Label Switching Transport Profile) network, among communication devices configuring the MPLS-TP network,

the non-edge device control method comprising, when the non-edge device receives a frame and in a case where header information of the frame includes an OAM (Operations, Administration and Maintenance) identifier and a communication device identified based on MPLS communication device identification information that is for identifying a communication device configuring the MPLS-TP network and that is included by the OAM identifier is the device itself, executing an OAM process based on a content of a process shown by process content information included by the frame.

### (Supplementary Note 24)

The non-edge device control method according to Supplementary Note 23, comprising transferring a frame when the non-edge device receives the frame and in a case where header information of the frame includes an OAM identifier and a communication device identified based on MPLS communication device identification information included by the OAM identifier is not the device itself.

### (Supplementary Note 25)

The non-edge device control method according to Supplementary Note 23 or 24, wherein the OAM identifier is included as a destination MAC (Medium Access Control) address into the header information.

### (Supplementary Note 26)

A non-edge device control program executed by a non-edge device, which is a communication device connected with only a communication device configuring a MPLS-TP (Multi Protocol Label Switching Transport Profile) network, among communication devices configuring the MPLS-TP network,

the non-edge device control program comprising instructions for causing the non-edge device to execute an OAM (Operations, Administration and Maintenance) process based on a content of a process shown by process content information included by a frame when the non-edge device receives the frame and in a case where header information of the frame includes an OAM identifier and a communication device identified based on MPLS communication device identification information that is for identifying the communication device configuring the MPLS-TP network and that is included by the OAM identifier is the device itself.

### (Supplementary Note 27)

The non-edge device control program according to Supplementary Note 26, comprising instructions for causing the non-edge device to transfer a frame when the non-edge device receives the frame and in a case where header information of the frame includes an OAM identifier and a communication device identified based on MPLS communication device identification information included by the OAM identifier is not the device itself.

### (Supplementary Note 28)

The non-edge device control program according to Supplementary Note 26 or 27, wherein the OAM identifier is included as a destination MAC (Medium Access Control) address into the header information.

The present invention is based upon and claims the benefit of priority from Japanese patent application No. 2011-238238, filed on Oct. 31, 2011, the disclosure of which is incorporated herein in its entirety by reference.

### INDUSTRIAL APPLICABILITY

The present invention can be applied to, for example, a communication system composed of an Ethernet™ network and a MPLS-TP (Multi Protocol Label Switching Transport Profile) network connected to each other.

### DESCRIPTION OF REFERENCE NUMERALS

1 communication system
11 frame control part
11a OAM process executing part
12 frame control part
12a OAM frame transmitting part
12b OAM process executing part
13 crossbar switch
21 frame control part
21a OAM process executing part
22 MPLS control part
22a encapsulation process executing part
22b OAM process executing part
22c frame transferring part
23 crossbar switch
31 MPLS control part
31a frame transferring part
31b OAM process executing part
32 MPLS control part
32a frame transferring part
32b OAM process executing part
33 crossbar switch
C1, CE1, PE1, P1, P2, PE2, CE2, C2 communication device
EN1, EN2 Ethernet network
MN MPLS-TP network
100 communication system
200 Ethernet network
210 communication device
211 OAM frame transmitting part
300 MPLS-TP network
310, 320 communication device
311 encapsulation process executing part
321 OAM process executing part.

1. A communication system in which an Ethernet™ network and a MPLS-TP (Multi Protocol Label Switching Transport Profile) network are connected with each other, wherein:
a communication device configuring the Ethernet network comprises an OAM frame transmitting unit for transmitting an OAM frame that includes frame type information showing that a frame type comprises an OAM (Operations, Administration and Maintenance) frame, MPLS communication device identification information for identifying a communication device configuring the MPLS-TP network, and process content information showing a content of a process;
an edge device, which is a communication device connected with the Ethernet network among communication devices configuring the MPLS-TP network, comprises an encapsulation process executing unit for, when the edge device receives a frame from the Ethernet network, executing an encapsulation process of providing the frame with header information for transferring the frame through the MPLS-TP network;
the encapsulation process executing unit is configured to, in a case where frame type information included by the received frame shows that a frame type comprises an OAM frame, provide the frame with header information including an OAM identifier including MPLS communication device identification information included by the frame; and
the communication device configuring the MPLS-TP network comprises an OAM process executing unit for, when the communication device receives a frame and in a case where header information of the frame includes an OAM identifier and a communication device identified based on MPLS communication device identification information included by the OAM identifier comprises the device itself, executing an OAM process based on a content of a process shown by process content information included by the frame.

2. The communication system according to claim 1, wherein the communication device configuring the MPLS-TP network comprises a frame transferring unit for, when the communication device receives a frame and in a case where header information of the frame includes an OAM identifier and a communication device identified based on MPLS communication device identification information included by the OAM identifier is not the device itself, transferring the frame.

3. The communication system according to claim 1, wherein the encapsulation process executing unit is configured to include the OAM identifier as a destination MAC (Medium Access Control) address into the header information.

4. The communication system according to claim 1, wherein:
the frame includes port specification information for specifying a port to be subjected to the OAM process; and
the OAM process executing unit is configured to execute the OAM process on the port specified based on the port specification information.

5. The communication system according to claim 1, wherein the MPLS communication device identification information includes MEP ID in a case where the communication device identified based on the MPLS communication device identification information comprises a MEP (Maintenance End Point) serving as an edge device that comprises a communication device connected with a communication network other than the MPLS-TP network among the communication devices configuring the MPLS-TP network.

6. The communication system according to claim 1, wherein the MPLS communication device identification information includes Node-ID in a case where the communication device identified based on the MPLS communication device identification information comprises a MIP (Maintenance Intermediate Point) serving as a non-edge device that comprises a communication device connected with only the communication device configuring the MPLS-TP network among the communication devices configuring the MPLS-TP network.

7. The communication system according to claim 1, wherein the OAM process is a loopback process of sending back the frame to a communication device that comprises a transmission source of the frame.

8. A communication method applied to a communication system in which an Ethernet™ network and a MPLS-TP (Multi Protocol Label Switching Transport Profile) network are connected with each other, the communication method comprising:
transmitting an OAM frame that includes frame type information showing that a frame type is an OAM (Operations, Administration and Maintenance) frame, MPLS communication device identification information for identifying a communication device configuring the MPLS-TP network, and process content information showing a content of a process, by a communication device configuring the Ethernet network; and
executing an encapsulation process of providing a frame with header information for transferring the frame through the MPLS-TP network when an edge device, which comprises a communication device connected with the Ethernet network among communication devices configuring the MPLS-TP network, receives the frame from the Ethernet network, by the edge device,
wherein the encapsulation process is configured to, in a case where frame type information included by the received frame shows that a frame type comprises an OAM frame, provide the frame with header information including an OAM identifier including MPLS communication device identification information included by the frame,
the communication method further comprising:
executing an OAM process based on a content of a process shown by process content information included by a frame when the communication device configuring the MPLS-TP network receives the frame and in a case where header information of the frame includes an OAM identifier and a communication device identified based on MPLS communication device identification information included by the OAM identifier comprises the device itself, by the communication device.

9. An edge device as a communication device connected with an Ethernet™ network among communication devices configuring a MPLS-TP (Multi Protocol Label Switching Transport Profile) network,
the edge device comprising an encapsulation process executing unit for, when the edge device receives a frame from the Ethernet network, executing an encapsulation process of providing the frame with header information for transferring the frame through the MPLS-TP network,
wherein the encapsulation process executing unit is configured to, in a case where frame type information included by the received frame shows that a frame type comprises an OAM (Operations, Administration and Maintenance) frame, provide the frame with header information including an OAM identifier including MPLS communication device identification information for identifying a communication device configuring the MPLS-TP network, the MPLS communication device identification information being included by the frame,
the edge device further comprising an OAM process executing unit for, when the edge device receives a frame and in a case where header information of the frame includes an OAM identifier and a communication device identified based on MPLS communication device identification information included by the OAM identifier is the device itself, executing an OAM process based on a content of a process shown by process content information included by the frame.

10. A non-edge device as a communication device connected with only a communication device configuring a MPLS-TP (Multi Protocol Label Switching Transport Profile) network, among communication devices configuring the MPLS-TP network,
the non-edge device comprising an OAM (Operations, Administration and Maintenance) process executing unit for, when the non-edge device receives a frame and in a case where header information of the frame includes an OAM identifier and a communication device identified based on MPLS communication device identification information that is for identifying the communication device configuring the MPLS-TP network and that is included by the OAM identifier comprises the device itself, executing an OAM process based on a content of a process shown by process content information included by the frame.
